(19) United States
(12) Patent Application Publication
(10) Pub. No.: US 2010/0040793 A1
(43) Pub. Date: Feb. 18, 2010

(54) Coating composition and method for forming multilayer topcoat film

(75) Inventors: Toshiyuki Hanaoka, Kanagawa (JP); Yoshiyuki Yukawa, Kanagawa (JP)

Correspondence Address: WENDEROTH, LIND & PONACK, L.L.P., 1030 15th Street, N.W.,, Suite 400 East, Washington, DC, 20005-1503, US

(73) Assignee: Kansai Paint Co., Ltd.

(21) Appl. No.: 12/311,167

(22) PCT Filed: Sep. 7, 2007
(86) PCT No.: PCT/JP2007/067895

§ 371 Date: Mar. 20, 2009

(30) Foreign Application Priority Data
Sep. 22, 2006 (JP) 2006-257331
Oct. 16, 2006 (JP) 2006-281181

(51) Int. Cl. B05D 1/36; C08L 67/06; C08L 63/00

(52) U.S. Cl. 427/407.1; 525/451; 524/539

(57) ABSTRACT

The present invention provides a coating composition comprising (A) a carboxy-containing reaction product with an acid value of 30 to 200 mg KOH/g and a number average molecular weight of 400 to 2,500 obtained by a half-esterification reaction of an acid anhydride with a polycarbonate diol prepared by reacting a C₂₋₁₀ diol with a carbonylating agent, (B) a carboxy-containing polymer, and (C) an epoxy-containing acrylic resin; and a method for forming a multilayer coating film using the coating composition.

### TECHNICAL FIELD

The present invention relates to a coating composition, and a method for forming a multilayer topcoat film using the coating composition.

### BACKGROUND ART

Topcoat compositions, and in particular clear topcoat compositions, applied to automobile bodies or like substrates, are required to provide excellent coating film performance in terms of scratch resistance, acid resistance, stain resistance, gloss, smoothness, etc. Recently, excellent scratch resistance and excellent acid resistance are regarded as being important to prevent scratches created by car washes, etching of coating films caused by acid rain, etc.

As such topcoat compositions, those in which hydroxy-containing resins are crosslinked with melamine resins have been mainly used. However, the crosslinkages formed by melamine resins are easily hydrolyzed by acid rain, and thus the resulting topcoats have the problem of poor acid resistance.

U.S. Pat. No. 4,650,718 and U.S. Pat. No. 4,681,811 disclose, as clear topcoat compositions for automobiles, coating compositions comprising a polyepoxide, such as an epoxy-containing acrylic polymer, and a polyacid curing agent, such as a carboxy-containing acrylic polymer or a carboxy-containing polyester. These patents state that the epoxy-containing acrylic polymer may have a silane functional group. Although coating films formed from these compositions have improved acid resistance because these coating compositions do not contain melamine resins, such coating films have insufficient scratch resistance.

U.S. Pat. No. 5,270,392 discloses, as a topcoat composition for automobiles, a coating composition comprising an epoxy- and hydroxy-containing compound and a copolymer of an acid anhydride group-containing monomer and other monomers, in which the acid anhydride group is half-esterified. However, coating films formed from the coating composition also have insufficient scratch resistance, although they have improved acid resistance.

U.S. Pat. No. 6,746,763 B2 discloses, as a clear topcoat composition that is suitable for automobile bodies and the like, a coating composition comprising a hydroxy- and epoxy-containing acrylic resin, a high-acid-value polyester resin, an alkoxysilyl-containing acrylic resin, and an acrylic resin containing a dimethylsiloxane side chain. However, coating films formed from the coating composition still have insufficient scratch resistance, although they have improved acid resistance.

### DISCLOSURE OF THE INVENTION

An object of the present invention is to provide a coating composition that is capable of forming a cured coating film with excellent performance in terms of scratch resistance, acid resistance, stain resistance, gloss, smoothness, etc., and that is suitable as a topcoat composition for automobile bodies and the like.

Another object of the present invention is to provide a method for forming a multilayer topcoat film using the coating composition.

The present inventors conducted extensive research to achieve the above objects, and found that the above objects can be achieved by a coating composition comprising a carboxy-containing reaction product (A) with a specific acid value and number average molecular weight obtained by a half-esterification reaction of a specific polycarbonate diol with an acid anhydride; a carboxy-containing compound (B); and an epoxy-containing acrylic resin (C). The present invention was accomplished based on the above new finding.

The present invention provides the following coating composition and method for forming a multilayer topcoat film.

Item 1. A coating composition comprising:

(A) a carboxy-containing reaction product with an acid value of 30 to 200 mg KOH/g and a number average molecular weight of 400 to 2,500 obtained by a half-esterification reaction of an acid anhydride with a polycarbonate diol prepared by reacting a C₂₋₁₀ diol with a carbonylating agent;
(B) a carboxy-containing polymer; and
(C) an epoxy-containing acrylic resin.

Item 2. The coating composition according to Item 1, wherein the C₂₋₁₀ diol is a mixture of 1,6-hexanediol and at least one member selected from the group consisting of 1,5-pentanediol, 1,4-butanediol, and 1,4-cyclohexanedimethanol.

Item 3. The coating composition according to Item 1, wherein the polycarbonate diol has a Brookfield viscosity of 10,000 mPa·s or less at 50° C.

Item 4. The coating composition according to Item 1, wherein the acid anhydride is at least one member selected from the group consisting of succinic anhydride, hexahydrophthalic anhydride, and trimellitic anhydride.

Item 5. The coating composition according to Item 1, wherein the carbonylating agent is at least one member selected from the group consisting of alkylene carbonate, dialkyl carbonate, diallyl carbonate, and phosgene.

Item 6. The coating composition according to Item 1, wherein the carboxy-containing polymer (B) has an acid value of 50 to 300 mg KOH/g.

Item 7. The coating composition according to Item 1, wherein the epoxy-containing acrylic resin (C) is an epoxy- and alkoxysilyl-containing acrylic resin.

Item 8. The coating composition according to Item 1, wherein the proportions of the carboxy-containing reaction product (A), carboxy-containing polymer (B), and epoxy-containing acrylic resin (C) are such that the equivalent ratio of carboxy groups in the components (A) and (B) relative to epoxy groups in the component (C) is 1:0.5 to 0.5:1.

Item 9. The coating composition according to Item 1, wherein the proportions of the carboxy-containing reaction product (A) and carboxy-containing polymer (B) are, on a solids basis, 10 to 60 mass % of the component (A) and 90 to 40 mass % of the component (B), relative to the total amount of the components (A) and (B).

Item 10. The coating composition according to Item 1, wherein the proportions of the carboxy-containing reaction product (A), carboxy-containing polymer (B), and epoxy-containing acrylic resin (C) are, on a solids basis, 20 to 80 mass % of the components (A) and (B) combined, and 80 to 20 mass % of the component (C), relative to the total amount of the components (A), (B), and (C).

Item 11. The coating composition according to Item 1, wherein the proportion of the carboxy-containing reaction product (A) is, on a solids basis, 3 to 30 mass %, relative to the total amount of the reaction product (A), carboxy-containing polymer (B), and epoxy-containing acrylic resin (C).

Item 12. The coating composition according to Item 1, further comprising a coloring pigment.

Item 13. A method for forming a multilayer topcoat film, the method comprising forming on a substrate one or two colored base coating layers, and one or two clear coating layers, wherein the uppermost clear coating layer is formed using the coating composition according to Item 1.

The coating composition and multilayer topcoat film-forming method of the present invention are described below in detail.

### Coating Composition

The coating composition of the present invention comprises a specific carboxy-containing reaction product (A), carboxy-containing polymer (B), and epoxy-containing acrylic resin (C).

Carboxy-Containing Reaction Product (A)

The carboxy-containing reaction product (A) is obtained by a half-esterification reaction of an acid anhydride with a polycarbonate diol prepared by reacting a C₂₋₁₀ diol with a carbonylating agent, and has an acid value of 30 to 200 mg KOH/g and a number average molecular weight of 400 to 2,500.

The polycarbonate diol, which is a synthetic intermediate for the reaction product (A), is a compound usually obtained by a polycondensation reaction of a diol with a carbonylating agent.

The diol used for the production of the polycarbonate diol is a dihydric alcohol having 2 to 10, and preferably 4 to 8, carbon atoms. Specific examples of such diols include 1,2-propanediol, 1,3-propanediol, 1,3-butanediol, 1,4-butanediol, 1,5-pentanediol, 1,6-hexanediol, 1,7-heptanediol, 1,8-octanediol, 2-ethyl-1,6-hexanediol, 2-methyl-1,3-propanediol, 3-methyl-1,5-pentanediol, neopentyl glycol, and like aliphatic diols; 1,3-cyclohexanediol, 1,4-cyclohexanediol, 1,4-cyclohexanedimethanol, and like alicyclic diols; p-xylenediol, p-tetrachloroxylenediol, and like aromatic diols; diethylene glycol, dipropylene glycol, and like ether diols; etc. Such diols can be used singly or in combination of two or more.

To provide a coating film with excellent durability and excellent hardness from the coating composition comprising the reaction product (A) obtained using the polycarbonate diol, the diol used for the production of the polycarbonate diol is preferably a combination of 1,6-hexanediol and at least one diol other than 1,6-hexanediol; and more preferably a combination of 1,6-hexanediol and at least one member selected from the group consisting of 1,5-pentanediol, 1,4-butanediol, and 1,4-cyclohexanedimethanol. Specific examples of such combinations include 1,6-hexanediol and 1,5-pentanediol; 1,6-hexanediol and 1,4-butanediol; 1,6-hexanediol and 1,4-cyclohexanedimethanol; etc.

Known carbonylating agents can be used. Specific examples include alkylene carbonates, dialkyl carbonates, diallyl carbonate, phosgene, etc. Such carbonylating agents can be used singly or in combination of two or more. Among these, preferable examples include ethylene carbonate, propylene carbonate, dimethyl carbonate, diethyl carbonate, dibutyl carbonate, diphenyl carbonate, etc.

The polycarbonate diol used as a synthetic intermediate for the reaction product (A) preferably has a Brookfield viscosity of about 10,000 mPa·s or less at 50° C. When the Brookfield viscosity is more than 10,000 mPa·s at 50° C., it becomes difficult to handle the polycarbonate diol, and the resulting coating film may have poor gloss or become cloudy because of poor compatibility of the reaction product (A) with the carboxy-containing compound (B) and acrylic resin (C).

The Brookfield viscosity at 50° C. of the polycarbonate diol used for the synthesis of the reaction product (A) is more preferably about 10 to about 10,000 mPa·s, still more preferably about 10 to about 8,000 mPa·s, and even more preferably about 10 to about 5,000 mPa·s.

As used herein, the Brookfield viscosity is measured using a Brookfield viscometer at 50° C. and 6 rpm.

To obtain a coating composition that can form a coating film with excellent acid resistance and excellent scratch resistance, the polycarbonate diol used for the synthesis of the reaction product (A) preferably has a number average molecular weight of about 300 to about 2,000, more preferably about 500 to about 1,800, and even more preferably about 700 to about 1,500.

As used herein, the number average molecular weight of resin was measured by GPC (gel permeation chromatography) using polystyrene standards. The number average molecular weights shown in the Production Examples and elsewhere, were measured using a GPC apparatus “HLC8120GPC” (tradename of TOSOH CORP.) and four columns “TSKgel G-4000HXL”, “TSKgel G-300HXL”, “TSKgel G-2500HXL”, and “TSKgel G-200HXL” (all tradenames of TOSOH CORP.), under the following conditions. Mobile phase: tetrahydrofuran; measurement temperature: 40° C.; flow rate: 1 cc/min; detector: RI.

The polycarbonate diol may be a commercial product. Commercially available polycarbonate diols include, for example, “T-5650J” (tradename of Asahi Kasei Chemicals Corp.; diol components: 1,6-hexanediol and 1,5-pentanediol); “T-4671” (tradename of Asahi Kasei Chemicals Corp.; diol components: 1,6-hexanediol and 1,4-butanediol); “UM-CARB90” (tradename of Ube Industries, Ltd.; diol components: 1,6-hexanediol and 1,4-cyclohexanedimethanol); etc.

Examples of acid anhydrides that can be used for the synthesis of the reaction product (A) include anhydrides of polycarboxylic acids such as phthalic acid, tetrahydrophthalic acid, hexahydrophthalic acid, methylhexahydrophthalic acid, succinic acid, glutaric acid, pimelic acid, naphthalenedicarboxylic acid, 4,4-diphenyletherdicarboxylic acid, diphenylmethane-4,4′-dicarboxylic acid, HET acid, maleic acid, fumaric acid, itaconic acid, trimellitic acid, hexahydrotrimellitic acid, pyromellitic acid, etc. Such acid anhydrides can be used singly or in combination of two or more.

Among these, succinic anhydride, hexahydrophthalic anhydride, and trimellitic anhydride can be preferably used from the viewpoint of excellent acid resistance, excellent scratch resistance, etc., of the coating film.

The reaction product (A) is usually synthesized under such conditions that the polycarbonate diol does not undergo polycondensation with the acid anhydride and that terminal hydroxy groups of the polycarbonate diol are converted to carboxy groups through half-esterification. The reaction product (A) may contain an unreacted portion that is not half-esterified, as long as the reaction product (A) has an acid value and number average molecular weight within the specific ranges.

The optimum temperature for the half-esterification reaction varies depending mainly on the melting point and the like of the acid anhydride used. For example, when using hexahydrophthalic anhydride as the acid anhydride, the optimum temperature is about 120 to about 180° C. Generally, a polycondensation reaction is likely to occur at temperatures of more than about 200° C.

The reaction product (A) can be synthesized by carrying out a half-esterification reaction of a polycarbonate diol and an acid anhydride in such proportions that the equivalent ratio (acid anhydride groups in the acid anhydride/hydroxy groups in the polycarbonate diol) becomes about 1.05 or less. To achieve excellent curability of the coating composition and excellent water resistance and other properties of the coating film, the equivalent ratio is preferably about 0.25 to about 1.05, more preferably about 0.5 to about 1.0, and even more preferably about 0.75 to about 1.0.

In the reaction product (A), the lower the equivalent ratio, the greater the proportion of the portion in which only one end of the polycarbonate diol has been converted to a carboxy group; and the higher the equivalent ratio, the greater the proportion of the portion in which both ends of the polycarbonate diol have been converted to carboxy groups.

Further, the lower the equivalent ratio, the greater the amount of unreacted polycarbonate diol remaining in the reaction product (A). In the present invention, in such a case, hydroxy groups in the polycarbonate diol can also be reacted with epoxy groups or alkoxysilyl groups. Therefore, the reaction product (A) containing unreacted polycarbonate diol can usually be used as it is, without isolating the unreacted polycarbonate diol.

To achieve excellent compatibility of the reaction product (A) with the carboxy-containing compound (B) and epoxy-containing acrylic resin (C), excellent curability of the coating composition, and excellent coating film performance in terms of scratch resistance, water resistance, etc., the reaction product (A) needs to have an acid value of about 30 to about 200 mg KOH/g. For the same purpose, the reaction product (A) preferably has an acid value of about 50 to about 150 mg KOH/g, and more preferably about 60 to about 130 mg KOH/g.

To achieve excellent compatibility of the reaction product (A) with the carboxy-containing compound (B) and acrylic resin (C), and excellent coating film performance in terms of scratch resistance, hardness, weather resistance, etc., the reaction product (A) needs to have a number average molecular weight of about 400 to about 2,500. For the same purpose, the reaction product (A) preferably has a number average molecular weight of about 500 to about 2,000, and more preferably about 700 to about 1,500.

From the viewpoint of excellent curability and other properties of the resulting coating composition, the reaction product (A) preferably has a hydroxy value of about 0 to about 150 mgK OH/g, and more preferably about 0 to about 100 mg KOH/g.

In the present invention, the acid value, number average molecular weight, and hydroxy value of the reaction product (A) mean those of the reaction product as a whole including polycarbonate diol that remains unreacted.

Carboxy-Containing Polymer (B)

The carboxy-containing polymer (B) may be a known carboxy-containing polymer other than the reaction product (A). Preferable examples of the carboxy-containing polymer (B) include a vinyl polymer (B-1) containing half-esterified acid anhydride group(s), and a carboxy-containing polyester polymer (B-2).

Half-Esterified Acid Anhydride Group-Containing Vinyl Polymer (B-1)

The term “half-esterified acid anhydride group” as used herein means a group comprising carboxy and carboxylate groups, which is obtained by adding an aliphatic monohydric alcohol to an acid anhydride group to perform ring opening (i.e., half-esterification). The half-esterified acid anhydride group is hereinafter sometimes referred to simply as “half ester group”.

The polymer (B-1) can be easily obtained by, for example, copolymerizing a half ester group-containing vinyl monomer with other vinyl monomers by a standard method. The polymer (B-1) can also be easily obtained by carrying out copolymerization in a similar manner using an acid anhydride group-containing vinyl monomer in place of the half ester group-containing vinyl monomer, and then half-esterifying the acid anhydrous group. The polymer (B-1) can also be obtained by carrying out copolymerization in a similar manner using a hydroxy-containing vinyl monomer in place of the half ester group-containing vinyl monomer, and then half-esterifying the hydroxy group.

Examples of half ester group-containing vinyl monomers include compounds obtained by half-esterifying acid anhydride groups of acid anhydride group-containing vinyl monomers; compounds obtained by adding acid anhydrides to hydroxy-containing vinyl monomers by half-esterification; etc.

Specific examples of compounds obtained by half-esterifying acid anhydride groups of acid anhydride group-containing vinyl monomers include monoesters of acid anhydride group-containing vinyl monomers, such as maleic anhydride, itaconic anhydride, etc., with aliphatic monoalcohols; and the like.

Specific examples of compounds obtained by adding acid anhydrides to hydroxy-containing vinyl monomers by half-esterification include compounds obtained by adding, by half-esterification, acid anhydrides, such as phthalic anhydride, hexahydrophthalic anhydride, etc., to hydroxy-containing vinyl monomers mentioned hereinafter as other vinyl monomers.

As mentioned above, the half-esterification can be carried out either before or after the copolymerization reaction. Examples of aliphatic monohydric alcohols that can be used for the half-esterification include low-molecular-weight monohydric alcohols, such as methanol, ethanol, isopropanol, tert-butanol, isobutanol, ethylene glycol monomethyl ether, ethylene glycol monoethyl ether, etc. The half-esterification reaction can be carried out by a conventional method, at room temperature to about 80° C., using, if necessary, tertiary amine as a catalyst.

Examples of other vinyl monomers mentioned above include hydroxy-containing vinyl monomers; (meth)acrylic acid esters; vinyl ethers and allyl ethers; olefinic compounds and diene compounds; nitrogen-containing unsaturated monomers; styrene, α-methylstyrene, vinyltoluene; etc.

Examples of hydroxy-containing vinyl monomers include C₂₋₈ hydroxyalkyl esters of acrylic or methacrylic acid, such as 2-hydroxyethyl (meth)acrylate, 3-hydroxypropyl (meth)acrylate, 4-hydroxybutyl (meth)acrylate, etc.; monoesters of polyether polyols, such as polyethylene glycol, polypropylene glycol, polybutylene glycol, etc., with unsaturated carboxylic acids, such as (meth)acrylic acid and the like; monoethers of polyether polyols, such as polyethylene glycol, polypropylene glycol, polybutylene glycol, etc., with hydroxy-containing unsaturated monomers, such as 2-hydroxyethyl (meth)acrylate and the like; diesters of acid anhydride group-containing unsaturated compounds, such as maleic anhydride, itaconic anhydride, etc., with glycols, such as ethylene glycol, 1,6-hexanediol, neopentyl glycol, etc.; hydroxyalkyl vinyl ethers such as hydroxyethyl vinyl ether and the like; allyl alcohol and the like; 2-hydroxypropyl (meth)acrylate; adducts of α,β-unsaturated carboxylic acids with monoepoxy compounds such as “Cardula E10” (tradename of Shell Petrochemical Co., Ltd.), α-olefin epoxide, etc; adducts of glycidyl (meth)acrylate with monobasic acids such as acetic acid, propionic acid, p-tert-butylbenzoic acid, aliphatic acids, etc.; adducts of the above hydroxy-containing monomers with lactones (e.g., ε-caprolactone, γ-valerolactone); and the like.

As used herein, “(meth)acrylate” means “acrylate or methacrylate”; “(meth)acrylic acid” means “acrylic acid or methacrylic acid”; and “(meth)acrylamide” means “acrylamide or methacrylamide”.

Examples of (meth)acrylic acid esters include C₁₋₂₄ alkyl esters or cycloalkyl esters of acrylic or methacrylic acid, such as methyl acrylate, ethyl acrylate, propyl acrylate, isopropyl acrylate, n-butyl acrylate, isobutyl acrylate, tert-butyl acrylate, hexyl acrylate, 2-ethylhexyl acrylate, n-octyl acrylate, decyl acrylate, stearyl acrylate, lauryl acrylate, cyclohexyl acrylate, methyl methacrylate, ethyl methacrylate, n-propyl methacrylate, isopropyl methacrylate, n-butyl methacrylate, isobutyl methacrylate, tert-butyl methacrylate, hexyl methacrylate, 2-ethylhexyl methacrylate, octyl methacrylate, decyl methacrylate, lauryl methacrylate, stearyl methacrylate, etc.; C₂₋₁₈ alkoxyalkyl esters of acrylic or methacrylic acid, such as methoxybutyl acrylate, methoxybutyl methacrylate, methoxyethyl acrylate, methoxyethyl methacrylate, ethoxybutyl acrylate, ethoxybutyl methacrylate, etc.; and the like.

Examples of vinyl ethers and allyl ethers include ethyl vinyl ether, n-propyl vinyl ether, isopropyl vinyl ether, butyl vinyl ether, tert-butyl vinyl ether, pentyl vinyl ether, hexyl vinyl ether, octyl vinyl ether, and like linear or branched alkyl vinyl ethers; cyclopentyl vinyl ether, cyclohexyl vinyl ether, and like cycloalkyl vinyl ethers; phenyl vinyl ether, trivinyl ether, and like allyl vinyl ethers; benzyl vinyl ether, phenethyl vinyl ether, and like aralkyl vinyl ethers; allyl glycidyl ether, allyl ethyl ether, and like allyl ethers; etc.

Examples of olefin compounds and diene compounds include ethylene, propylene, butylene, vinyl chloride, butadiene, isoprene, chloroprene, etc.

Examples of nitrogen-containing unsaturated monomers include N,N-dimethylaminoethyl (meth)acrylate, N,N-diethylaminoethyl (meth)acrylate, N-tert-butylaminoethyl (meth)acrylate, and like nitrogen-containing alkyl (meth)acrylates; acrylamide, methacrylamide, N-methyl (meth)acrylamide, N-ethyl (meth)acrylamide, N,N-dimethyl (meth)acrylamide, N,N-dimethylaminopropyl (meth)acrylamide, N,N-dimethylaminoethyl (meth)acrylamide, and like polymerizable amides; 2-vinylpyridine, 1-vinyl-2-pyrrolidone, 4-vinylpyridine, and like aromatic nitrogen-containing monomers; acrylonitrile, methacrylonitrile, and like polymerizable nitriles; allyamines; etc.

A mixture of monomers as mentioned above can be copolymerized by a generally employed method for copolymerizing vinyl monomers, but considering the versatility, cost, etc., solution radical polymerization in an organic solvent is preferable. When solution radical polymerization is employed, a desired copolymer can be easily obtained by carrying out a copolymerization reaction of a monomer mixture at about 60 to about 165° C. in an organic solvent in the presence of a polymerization initiator. Examples of the organic solvent include xylene, toluene, and like aromatic solvents; methyl ethyl ketone, methyl isobutyl ketone, and like ketone solvents; ethyl acetate, butyl acetate, isobutyl acetate, 3-methoxy butyl acetate, and like ester solvents; n-butanol, isopropyl alcohol, and like alcohol solvents; etc. Examples of the polymerization initiator include azobisisobutyronitrile, benzoyl peroxide, etc.

The proportions of the half ester group- or acid anhydride group-containing vinyl monomer and other vinyl monomers used in the copolymerization are usually as follows, relative to the total amount of monomers used: the proportion of the half ester group- or acid anhydride group-containing vinyl monomer is preferably about 5 to about 40 mass %, and more preferably about 10 to about 30 mass %, from the viewpoint of the balance between the curing reactivity and storage stability of the resulting copolymer; and the proportion of other vinyl monomers is preferably 60 to about 95 mass %, and more preferably about 70 to about 90 mass %. When an acid anhydride group-containing vinyl monomer is used, a half-esterification reaction is carried out after the copolymerization reaction, as described above.

To achieve an excellent compatibility of the polymer (B-1) with the reaction product (A) and epoxy-containing acrylic resin (C), and to obtain a coating film with excellent gloss, excellent acid resistance, etc., from the coating composition containing the polymer (B-1), the polymer (B-1) is preferably an acrylic polymer having a number average molecular weight of about 1,000 to about 10,000, and more preferably about 1,200 to about 7,000, and an acid value of about 50 to about 250 mg KOH/g, and more preferably about 100 to about 200 mg KOH/g.

Carboxy-Containing Polyester Polymer (B-2)

The number average molecular weight of the polymer (B-2) is not limited, but it is usually preferable that the number average molecular weight be about 500 to about 10,000, and more preferably about 800 to about 5,000, to obtain a coating film with excellent gloss, excellent acid resistance, etc., from the coating composition containing the polymer (B-2).

The carboxy-containing polyester polymer can be easily obtained by a condensation reaction of a polyhydric alcohol with a polycarboxylic acid. For example, the carboxy-containing polyester polymer can be obtained by a one-step reaction under such conditions that carboxy groups of the polycarboxylic acid are present in excess. Alternatively, the carboxy-containing polyester polymer can be obtained by first synthesizing a hydroxy-terminated polyester polymer under such conditions that hydroxy groups of the polyhydric alcohol are present in excess, and thereafter adding an acid anhydride-containing compound.

Examples of the polyhydric alcohol include ethylene glycol, butylene glycol, 1,6-hexanediol, 2-butyl-2-ethyl-1,3-propanediol, 3-methyl-1,5-pentanediol, trimethylolpropane, pentaerythritol, etc. Examples of polycarboxylic acids include adipic acid, terephthalic acid, isophthalic acid, phthalic anhydride, hexahydrophthalic anhydride, etc. Examples of acid anhydride group-containing compounds include phthalic anhydride, hexahydrophthalic anhydride, succinic anhydride, etc.

To improve the compatibility of the carboxy-containing polyester polymer (B-2) with the reaction product (A) and epoxy-containing acrylic resin (C) and to obtain a coating film with improved adhesion from the coating composition containing the polymer (B-2), hydroxy groups can be introduced into the polymer (B-2) to such an extent that the polymer (B-2) has a hydroxy value of about 100 mg KOH/g or less. When the conditions are such that carboxy groups are present in excess, hydroxy groups can be introduced by, for example, terminating the condensation reaction during the course thereof; and when the conditions are such that hydroxy groups are present in excess, hydroxy groups can be easily introduced by first synthesizing a hydroxy-terminated polyester polymer and then adding an acid anhydride group-containing compound so that the amount of acid groups is smaller than that of hydroxy groups.

A particularly preferable example of the carboxy-containing polyester polymer is the following carboxy-containing, high-acid-value polyester. The term “high-acid-value polymer” as used herein usually means a polymer with an acid value of more than 70 mg KOH/g.

The carboxy-containing, high-acid-value polyester can be easily obtained by performing an esterification reaction of a polyhydric alcohol with a polycarboxylic acid or a lower alkyl ester thereof, under such conditions that the amount of hydroxy groups is in excess of the amount of carboxy groups, to obtain a polyester polyol, which is then subjected to a half-esterification reaction with an acid anhydride group-containing compound. The carboxy group encompasses acid anhydride groups, and, when calculating the amount of carboxy groups, 1 mol of acid anhydride groups is counted as 2 mol of carboxy groups. The esterification reaction may be either a condensation reaction or transesterification reaction.

The above polyester polyol can be obtained under conventional esterification reaction conditions. It is preferable that the polyester polyol have a number average molecular weight of about 350 to about 4,700, and more preferably about 400 to about 3,000; and a hydroxy value of about 70 to about 400 mg KOH/g, and more preferably about 150 to about 350 mg KOH/g. The half-esterification reaction of the polyester polyol can be carried out by a conventional method, usually at room temperature to about 80° C., using, if necessary, a tertiary amine as a catalyst.

Examples of polyhydric alcohols include ethylene glycol, butylene glycol, 1,6-hexanediol, trimethylolpropane, pentaerythritol, etc. Examples of polycarboxylic acids include adipic acid, sebacic acid, terephthalic acid, isophthalic acid, phthalic anhydride, hexahydrophthalic anhydride, trimellitic anhydride, etc. Examples of acid anhydride group-containing compounds include phthalic anhydride, hexahydrophthalic anhydride, succinic anhydride, trimellitic anhydride, etc.

It is preferable that the carboxy-containing, high-acid-value polyester have a number average molecular weight of about 800 to about 5,000, and more preferably about 900 to about 4,000, and an acid value of about 80 to about 300 mg KOH/g, and more preferably about 100 to about 250 mg KOH/g.

Epoxy-Containing Acrylic Resin (C)

The epoxy-containing acrylic resin (C) functions as a crosslinking-curing agent for the carboxy-containing reaction product (A) and carboxy-containing polymer (B).

The epoxy-containing acrylic resin (C) may contain, in addition to an epoxy group, an alkoxysilyl group. When the acrylic resin (C) contains an alkoxysilyl group, the coating film of the composition containing the acrylic resin (C) has a higher crosslinking density, and is improved in scratch resistance and stain resistance.

The acrylic resin (C) can be synthesized by copolymerizing an epoxy-containing vinyl monomer with other vinyl monomers, or copolymerizing an epoxy-containing vinyl monomer, alkoxysilyl-containing vinyl monomer, and other vinyl monomers.

Examples of epoxy-containing vinyl monomers include glycidyl (meth)acrylate, allyl glycidyl ether, 3,4-epoxycyclohexylmethyl (meth)acrylate, etc.

Alkoxysilyl-containing vinyl monomers include, for example, vinyltrimethoxysilane, vinylmethyldimethoxysilane, vinyltriethoxysilane, vinylmethyldiethoxysilane, vinyltris(2-methoxyethoxy)silane, γ-(meth) acryloyloxypropyltrimethoxysilane, γ-(meth)acryloyloxypropylmethyldimethoxysilane, vinyltriacetoxysilane, β-(meth)acryloyloxyethyltrimethoxysilane, γ-(meth)acryloyloxypropyltriethoxysilane, γ-(meth)acryloyloxypropylmethyldiethoxysilane, etc. Among these, to obtain excellent low-temperature curability and excellent storage stability, alkoxysilyl-containing vinyl monomers in which the alkoxysilyl groups are ethoxysilyl groups, such as vinyltriethoxysilane, vinylmethyldiethoxysilane, γ-(meth)acryloyloxypropyltriethoxysilane, γ-(meth)acryloyloxypropylmethyldiethoxysilane, etc.

Examples of other vinyl monomers are the same as those mentioned in the description of the polymer (B-1).

The copolymerization method mentioned in the description of the polymer (B-1) can be used for the copolymerization for producing the epoxy-containing acrylic resin (C).

To improve the compatibility of the epoxy-containing acrylic resin (C) with the reaction product (A) and carboxy-containing polymer (B), and to obtain a coating film with improved adhesion from the composition containing the acrylic resin (C), hydroxy groups can be introduced into the acrylic resin (C) to such an extent that the acrylic resin has a hydroxy value of about 150 mg KOH/g or less.

Hydroxy groups can be introduced by carrying out copolymerization using a hydroxy-containing vinyl monomer as a comonomer. Examples of hydroxy-containing vinyl monomers are the same as those mentioned in the description of the polymer (B-1).

When copolymerizing the epoxy-containing vinyl monomer and other vinyl monomers, from the viewpoint of the balance between the curing reactivity and storage stability of the resulting copolymer, the proportion of the epoxy-containing vinyl monomer is preferably about 5 to about 80 mass %, and more preferably about 10 to about 65 mass %. The proportion of other vinyl monomers is preferably 20 to about 95 mass %, and more preferably about 35 to about 90 mass %.

For copolymerization of the epoxy-containing vinyl monomer, alkoxysilyl-containing vinyl monomer, and other monomers, it is usually preferable to use the monomers in the following proportions, relative to the total amount of monomers used: the proportion of the epoxy-containing vinyl monomer is preferably about 5 to about 60 mass %, and more preferably about 10 to about 40 mass %, from the viewpoint of the balance between the curing reactivity and storage stability of the resulting copolymer; the proportion of the alkoxysilyl-containing vinyl monomer is preferably about 3 to about 40 mass %, and more preferably about 5 to about 30 mass %, to achieve excellent curing reactivity of the resulting copolymer and to obtain a coating film with excellent scratch resistance from the coating composition containing the resulting copolymer; and the proportion of the other vinyl monomers is preferably about 10 to about 80 mass %, and more preferably about 20 to about 50 mass %.

To achieve excellent compatibility of the acrylic resin (C) with the reaction product (A) and carboxy-containing polymer (B) and excellent curability of the resulting coating composition, and to obtain a coating film with excellent acid resistance and excellent scratch resistance from the composition, the epoxy group content of the acrylic resin (C) is preferably about 0.5 to about 5.5 mmol/g, and more preferably about 0.8 to about 4.5 mmol/g.

When the acrylic resin (C) has alkoxysilyl group(s), the amount of alkoxysilyl groups is preferably about 0.3 to about 5.0 mmol/g, and more preferably about 0.8 to about 3.5 mmol/g, to achieve excellent storage stability of the coating composition and excellent acid resistance and excellent scratch resistance of the coating film of the coating composition.

To achieve excellent compatibility of the acrylic resin (C) with the reaction product (A) and carboxy-containing polymer (B), and to obtain a coating film with excellent acid resistance and excellent scratch resistance, the acrylic resin (C) preferably has a number average molecular weight of about 1,000 to about 10,000, and more preferably about 1,200 to about 7,000.

In the coating composition of the present invention, the proportions of the carboxy-containing reaction product (A), carboxy-containing compound (B), and epoxy-containing acrylic resin (C) are preferably such that the equivalent ratio of carboxy groups in the components (A) and (B) relative to epoxy groups in the component (C) is about 1:0.5 to about 0.5:1, and more preferably about 1:0.6 to about 0.6:1.

Further, to provide a coating film that is excellent in scratch resistance, hardness, stain resistance, etc., the proportions of the carboxy-containing reaction product (A) and carboxy-containing polymer (B) are, on a solids basis, preferably about 10 to about 60 mass %, more preferably about 15 to about 50 mass %, and even more preferably about 20 to about 40 mass %, of the component (A), and preferably about 90 to about 40 mass %, more preferably about 85 to about 50 mass %, and even more preferably about 80 to about 60 mass %, of the component (B), relative to the total amount of the components (A) and (B).

To obtain a coating film that is excellent in scratch resistance, hardness, stain resistance, etc., the proportions of the carboxy-containing reaction product (A), carboxy-containing polymer (B), and epoxy-containing acrylic resin (C) are such that, on a solids basis, the proportion of the components (A) and (B) combined is preferably about 20 to about 80 mass %, and more preferably about 35 to about 65 mass %, and the proportion of the component (C) is preferably about 80 to about 20 mass %, and more preferably about 65 to about 35 mass %, relative to the total amount of the components (A), (B), and (C).

Further, to provide a coating film that is excellent in acid resistance, scratch resistance, hardness, stain resistance, etc., the proportion of the carboxy-containing reaction product (A) is, on a solids basis, preferably about 3 to about 30 mass %, and more preferably about 5 to about 25 mass %, relative to the total amount of the reaction product (A), carboxy-containing polymer (B), and epoxy-containing acrylic resin (C).

Other Components

In the coating composition of the present invention, to improve the scratch resistance, gloss, etc., a polycarbonate diol can be used as an additional resin component. Preferable examples of polycarbonate diols are those mentioned as carbonylating agents for use in the production of the reaction product (A).

When adding a polycarbonate diol, the amount thereof is preferably about 5 to about 75 parts by mass, and more preferably about 6 to about 50 parts by mass, per 100 parts by mass of the reaction product (A). The reaction product (A) itself may contain unreacted polycarbonate diol. In such a case, the above amounts of polycarbonate diol are relative to 100 parts by weight of the reaction product (A) including the unreacted polycarbonate diol.

The coating composition of the present invention may contain a curing catalyst, if necessary. Usable curing catalysts include those that are effective for the crosslinking reaction of carboxy groups and epoxy groups, such as tetraethylammonium bromide, tetrabutylammonium bromide, tetraethylammonium chloride, tetrabutylphosphonium bromide, triphenylbenzylphosphonium chloride, and like quaternary salt catalysts; triethylamine, tributylamine, and like amines; etc. Among these, quaternary salt catalysts are preferable. A mixture of substantially equivalent amounts of a quaternary salt and a phosphoric acid compound such as monobutyl phosphate, dibutyl phosphate, or the like, is particularly preferable, because such a mixture improves the storage stability of the coating composition and prevents the decrease of spray coating suitability caused by the reduction of the electric resistance of the coating composition, while retaining catalytic action.

The coating composition of the present invention may contain a dehydrating agent, such as trimethyl orthoacetate, in order to suppress the deterioration of the coating composition caused by moisture that is present in the coating composition and in the air.

The coating composition of the present invention may contain known pigments, such as coloring pigments, extender pigments, luster pigments, rust preventive pigments, etc., if necessary.

Examples of coloring pigments include titanium oxide, zinc oxide, carbon black, cadmium red, molybdenum red, chromium yellow, chromium oxide, Prussian blue, cobalt blue, azo pigments, phthalocyanine pigments, quinacridone pigments, isoindoline pigments, indanthrene pigments, perylene pigments, etc. Examples of extender pigments include talc, clay, kaolin, baryta, barium sulfate, barium carbonate, calcium carbonate, silica, alumina white, etc. Examples of luster pigments includes aluminum powder, mica powder, titanium oxide-coated mica powder, etc.

The coating composition of the present invention may also contain, if necessary, various resins such as acrylic resins, polyester resins, alkyd resins, silicon resins, fluororesins, etc. The composition may further contain a small amount of crosslinking agent, such as a melamine resin, blocked polyisocyanate compound, etc. Further, it is also possible to add conventional additives for coating compositions, such as UV absorbers, light stabilizers, anti-oxidants, surface adjusting agents, anti-foaming agents, etc., as required.

Known UV absorbers can be used, including, for example, benzotriazol UV absorbers, triazine UV absorbers, salicylic acid derivative UV absorbers, benzophenone UV absorbers, etc. The use of a UV absorber improves the weather resistance, yellowing resistance, etc., of the coating film.

The proportion of UV absorber in the coating composition is usually about 0 to about 10 parts by mass, preferably about 0.2 to about 5 parts by mass, and more preferably about 0.3 to about 2 parts by mass, per 100 parts by mass of the total resin solids in the composition.

Known light stabilizers are usable, including, for example, hindered amine light stabilizers and the like. The use of a light stabilizer improves the weather resistance, yellowing resistance, etc., of the coating film.

The proportion of light stabilizer in the coating composition is usually about 0 to about 10 parts by mass, preferably about 0.2 to about 5 parts by mass, and more preferably about 0.3 to about 2 parts by mass, per 100 parts by mass of the total resin solids in the composition.

The form of the coating composition of the present invention is not limited, but the composition is usually used as an organic solvent-based coating composition. In that case, usable organic solvents include various organic solvents for coating compositions, such as aromatic or aliphatic hydrocarbon solvents; alcohol solvents; ester solvents; ketone solvents; ether solvents; etc. To prepare the organic solvent-based coating composition, the organic solvent used for preparing the components (A), (B), (C), or the like, may be used as such; or an organic solvent may be further added.

### Method for Preparing Coating Composition

The coating composition of the present invention can be prepared by mixing, by a known method, the carboxy-containing reaction product (A), carboxy-containing polymer (B), epoxy-containing acrylic resin (C), and optional components such as polycarbonate diols, curing catalysts, pigments, resins, UV absorbers, light stabilizers, organic solvents, etc. The solids content of the coating composition of the present invention is preferably about 30 to about 70 mass %, and more preferably about 40 to about 60 mass %.

### Application Method

The coating composition of the invention can be advantageously used in various application methods described below.

Substrate

Examples of substrates to be coated include bodies of automobiles, motorcycles, and like vehicles; parts thereof; etc. Examples of substrates also include those that constitute such vehicle bodies and the like, such as cold rolled steel sheets and plates, galvanized steel sheets and plates, zinc alloy-plated steel sheets and plates, stainless steel sheets and plates, tinned steel sheets and plates, and like steel sheets and plates, aluminum sheets and plates, aluminum alloy sheets and plates, and like metal substrates; plastic substrates; and the like.

Usable substrates also include such vehicle bodies, parts, and metal substrates whose metal surface has been subjected to a chemical conversion treatment such as phosphate treatment, chromate treatment, composite oxide treatment, or the like. Usable substrates further include such vehicle bodies, metal substrates, and the like onto which an undercoat, such as an electrodeposition undercoat, and/or an intermediate coat, has been formed.

Application and Curing Method

The method of applying the coating composition of the invention is not limited. For example, air spray coating, airless spray coating, rotary atomization coating, curtain coating, and like application methods can be used to form a wet coat. In air spray coating, airless spray coating, and rotary atomization coating, an electrostatic charge may be applied, if necessary. Among these, air spray coating and rotary atomization coating are particularly preferable. It is usually preferable to apply the coating composition to a film thickness of about 10 to about 50 μm (when cured).

The wet coat is cured by heating. Heating can be performed by known heating means. For example, drying furnaces, such as hot air furnaces, electric furnaces, infrared induction heating furnaces, etc., can be used.

The heating temperature is usually about 100° C. to about 180° C., and preferably about 120° C. to about 160° C. The heating time is usually about 5 to about 60 minutes.

### Method of Forming Multilayer Topcoat Film

The coating composition of the present invention is capable of forming a coating film with excellent performance in terms of scratch resistance, acid resistance, stain resistance, gloss, etc. It is therefore preferable to use the coating composition as a clear coating composition for forming a top clear coat, in a method for forming a multilayer topcoat film on a substrate.

The multilayer topcoat-forming method of the invention is therefore a method for forming on a substrate one or two colored base coating layers and one or two clear coating layers, the uppermost clear coating layer being formed by using the coating composition of the invention.

Especially preferable substrates to which the multilayer topcoat-forming method of the invention can be applied are automobile bodies and parts thereof.

Specific examples of the multilayer topcoat-forming method of the invention include the following methods (a) to (c) wherein the coating composition of the invention is used to form the top clear coating layer.

Method (a): a two-coat method for forming a multilayer topcoat film, wherein a colored base coating layer and a top clear coating layer are formed in that order on a substrate.

Method (b): a three-coat method for forming a multilayer topcoat film, wherein a colored base coating layer, a clear coating layer and a top clear coating layer are formed in that order on a substrate.

Method (c): a three-coat method for forming a multilayer topcoat film, wherein a first colored base coating layer, a second colored base coating layer, and a top clear coating layer are formed in that order on a substrate.

The steps for forming a topcoat film in methods (a), (b), and (c) are described below in detail.

In the above methods, the colored base coating composition and the clear coating composition can be applied by application methods such as airless spray coating, air spray coating, rotary atomization coating, etc. In such application methods, an electrostatic charge may be applied, if necessary.

In method (a), a known colored coating composition can be used for forming the colored base coating layer.

A coating composition for automobile bodies or the like is preferably used as the colored base coating composition.

The colored base coating composition is an organic solvent-based or aqueous coating composition comprising a base resin, a crosslinking agent, a coloring pigment, a metallic pigment, a light interference pigment, an extender pigment, etc.

Examples of base resins include acrylic resins, vinyl resins, polyester resins, alkyd resins, urethane resins, and the like. Such resins can be used singly or in combination of two or more. Such base resins have crosslinkable functional groups such as hydroxy, epoxy, carboxy, alkoxysilyl, and the like. Examples of crosslinking agents include alkyl-etherified melamine resins, urea resins, guanamine resins, polyisocyanate compounds, blocked polyisocyanate compounds, epoxy compounds, carboxy-containing compounds, and the like. Such crosslinking agents can be used singly or in combination of two or more. The proportions of base resin and crosslinking agent are preferably about 50 to about 90 wt. % of base resin, and about 50 to about 10 wt. % of crosslinking agent, relative to the total amount of these components.

In method (a), the colored base coating composition is applied to a substrate to a film thickness of about 10 to about 50 μm (when cured). The applied base coating composition is either cured by heating at about 100° C. to about 180° C., preferably at about 120° C. to about 160° C., for about 10 to about 40 minutes or is not cured, with the coated substrate being left to stand at room temperature for several minutes or being preheated at about 40° C. to about 100° C. for about 1 to about 20 minutes.

Subsequently, the clear coating composition of the invention is applied to a film thickness of about 10 to about 70 μm (when cured) to form a top clear coating layer, and then heated to form a cured multilayer coating film. The heating is performed at about 100° C. to about 180° C., preferably at about 120° C. to about 160° C., for about 10 to about 40 minutes.

Of the above two-coat methods, the method comprising applying a base coating composition, applying a clear coating composition without heat-curing the base coating layer, and then curing the resulting two coating layers simultaneously is referred to as a two-coat one-bake method. The method comprising applying and heat-curing a base coating composition and then applying and curing a clear coating composition is referred to as a two-coat two-bake method.

In method (b), examples of usable colored base coating compositions are the same as those described in method (a). The first clear coating composition for forming a clear coating layer may be any composition for forming clear coating films. Examples of usable clear coating compositions include those that have formulations similar to the above-mentioned known colored base coating compositions but contain no or substantially no pigment. The coating composition of the invention is used as the second clear coating composition for forming the top clear coating layer. Alternatively, the clear coating composition of the invention may also be used as the first clear coating composition, so that both the clear coating layer and the top clear coating layer are formed from the clear coating composition of the invention.

In method (b), as in method (a), a colored base coating composition is applied to the substrate, and is either cured by heating, or not cured, with the coated substrate being left to stand at room temperature for several minutes or being preheated. Thereafter, a first clear coating composition is applied to the surface of the colored base coating layer to a film thickness of about 10 to about 50 μm (when cured), and is either cured by heating at about 100° C. to about 180° C., preferably at about 120° C. to about 160° C., for about 10 to about 40 minutes, or is not cured, with the coated substrate being left to stand at room temperature for several minutes or being preheated.

Subsequently, the coating composition of the invention is applied as a second clear coating composition to a film thickness of about 10 to about 50 μm (when cured) and then heated to form a cured multilayer coating film. The heating conditions are as in method (a).

The method comprising applying a base coating composition, applying a first clear coating composition without heat-curing the base coating layer, applying a second clear coating composition without curing the first clear coating layer, and then curing the resulting three coating layers simultaneously is referred to as a three-coat one-bake method. The method comprising applying a base coating composition, applying a first clear coating composition without heat-curing the base coating layer, curing the resulting two coating layers simultaneously and then applying and curing a second clear coating composition is referred to as a three-coat two-bake method. The method comprising applying and heat-curing a base coating composition, applying and curing a first clear coating composition, and applying and curing a second clear coating composition is referred to as a three-coat three-bake method.

Examples of colored base coating compositions usable as the first colored base coating composition in method (c) are the same as described in method (a).

In method (c), as in method (a), a first colored base coating composition is applied to the substrate, and is either cured by heating, or not cured, with the coated substrate being left to stand at room temperature for several minutes or being preheated. The second colored base coating composition is then applied to the surface of the first colored base coating layer to a film thickness of about 10 to about 50 μm (when cured), and is either cured by heating at about 100° C. to about 180° C., preferably at about 120° C. to about 160° C., for about 10 to about 40 minutes, or not cured, with the coated substrate being left to stand at room temperature for several minutes or being preheated.

Subsequently, the coating composition of the invention is applied as a composition for forming a top clear coating layer, to a film thickness of about 10 to about 50 μm (when cured) and heated, to form a cured multilayer coating film. The heating conditions are as in method (a).

The method comprising applying a first base coating composition, applying a second base coating composition without heat-curing the first base coating layer, applying a clear coating composition without curing the second base coating layer, and then curing the resulting three coating layers simultaneously is referred to as a three-coat one-bake method. The method comprising applying and heat-curing a first base coating composition, applying a second base coating composition, applying a clear coating composition without curing the second base coating layer and then curing the resulting two coating layers simultaneously is referred to as a three-coat two-bake method. The method comprising applying and heat-curing a first base coating composition, applying and curing a second base coating composition, and applying and curing a clear coating composition is referred to as a three-coat three-bake method.

### EFFECTS OF THE INVENTION

The coating composition of the present invention, and the method for forming a multilayer topcoat film using the composition, can achieve the following remarkable effects.

(1) The coating composition of the present invention is capable of forming a coating film that is excellent in finishing properties such as gloss, smoothness, etc., because the carboxy-containing reaction product (A) with an acid value of 30 to 200 mg KOH/g and a number average molecular weight of 400 to 2,500, which is obtained by a half-esterification reaction of a specific polycarbonate diol with an acid anhydride, has good compatibility with the carboxy-containing polymer (B) and epoxy-containing acrylic resin (C).

(2) The coating film formed using the coating composition of the present invention is also excellent in scratch resistance, acid resistance, stain resistance, etc., because the reaction product (A) improves the physical properties, such as mechanical strength, of the coating film, and because the crosslinkages formed by the reaction of the reaction product (A) and the carboxy-containing compound (B) with the epoxy-containing acrylic resin (C), and the carbonate linkages of the reaction product (A) both have excellent hydrolysis resistance.

(3) The coating composition of the present invention can therefore be advantageously used as a topcoat composition, and in particular as a clear topcoat composition, that is applied to a substrate such as an automobile body.

(4) The multilayer topcoat film-forming method of the present invention is capable of forming a multilayer coating film with excellent film performance in terms of scratch resistance, acid resistance, stain resistance, gloss, smoothness, etc., on a substrate, such as an automobile body.

### BEST MODE FOR CARRYING OUT THE INVENTION

The following Production Examples, Examples, and Comparative Examples are provided to illustrate the present invention in further detail, and are not intended to limit the scope of the invention. In the following examples, parts and percentages are by mass unless otherwise stated, and the film thickness is the thickness of a cured coating film.

### Production of Carboxy-Containing Reaction Product (A)

### Production Examples 1-14

A polycarbonate diol and hydrocarbon organic solvent (tradename “Swasol 1000”, product of COSMO OIL CO., LTD.) shown in Table 1 or 2 were added to a four-necked flask equipped with a stirrer, a thermometer, a condenser tube, and a nitrogen gas inlet; and heated to 130° C. under a nitrogen atmosphere. After the temperature reached 130° C., an acid anhydride shown in Table 1 or 2 was added, and a reaction was carried out for 2 hours. Solutions of reaction products A-1 to A-14 were obtained in the above manner.

Tables 1 and 2 show the amounts (parts) of the starting materials, equivalent ratios of acid anhydride groups/hydroxy groups, solids contents (%) of the reaction product solutions, and properties of the reaction products.

TABLE 1

| | | Production Example | | | | | | |
|---|---|---|---|---|---|---|---|---|
| | | 1 | 2 | 3 | 4 | 5 | 6 | 7 |
| Reaction Product No. | | A-1 | A-2 | A-3 | A-4 | A-5 | A-6 | A-7 |
| Polycarbonate | T5650J(*1) | 500 | 500 | 500 | 500 | 500 | 500 | |
| Diol | T4671(*2) | | | | | | | 500 |
| | UM-CARB90(*3) | | | | | | | |
| | PC-M(*4) | | | | | | | |
| | PC-N(*5) | | | | | | | |
| | PC-O(*6) | | | | | | | |
| | PC-L(*7) | | | | | | | |
| | PC-H(*8) | | | | | | | |
| Solvent | Swasol 1000 | 300.0 | 270.4 | 400.0 | 279.0 | 257.5 | 231.6 | 283.4 |
| Acid Anhydride | Hexahydrophthalic | 201.5 | | | 151.0 | 100.8 | 40.3 | 161.2 |
| | Anhydride | | | | | | | |
| | Succinic Anhydride | | 130.9 | | | | | |
| | Trimellitic | | | 251.2 | | | | |
| | Anhydride | | | | | | | |
| Equivalent Ratio of | | 1 | 1 | 1 | 0.75 | 0.5 | 0.2 | 1 |
| Acid Anhydride Groups/Hydroxy | | | | | | | | |
| Groups | | | | | | | | |
| Solids Content (%) | | 70 | 70 | 60 | 70 | 70 | 70 | 70 |
| Properties | Acid Value | 110 | 118 | 183 | 85.2 | 62 | 27.2 | 88.8 |
| | (mg KOH/g) | | | | | | | |
| | Number Average | 1000 | 1000 | 990 | 980 | 950 | 920 | 1280 |
| | Molecular Weight | | | | | | | |
| | Hydroxy Value | 1> | 1> | 1> | 23 | 43 | 102 | 1> |
| | (mg KOH/g) | | | | | | | |

TABLE 2

| | | Production Example | | | | | | |
|---|---|---|---|---|---|---|---|---|
| | | 8 | 9 | 10 | 11 | 12 | 13 | 14 |
| Reaction Product No. | | A-8 | A-9 | A-10 | A-11 | A-12 | A-13 | A-14 |
| Polycarbonate | T5650J(*1) | | | | | | | |
| Diol | T4671(*2) | | | | | | | |
| | UM-CARB90(*3) | 500 | 500 | | | | | |
| | PC-M(*4) | | | 500 | | | | |
| | PC-N(*5) | | | | 500 | | | |
| | PC-O(*6) | | | | | 500 | | |
| | PC-L(*7) | | | | | | 500 | |
| | PC-H(*8) | | | | | | | 500 |
| Solvent | Swasol 1000 | 287.5 | 261.7 | 248.8 | 374.7 | 291.3 | 396.2 | 371.7 |
| Acid Anhydride | Hexahydrophthalic | 170.2 | | 80.6 | 374.2 | 180.0 | 424.6 | 57.6 |
| | anhydride | | | | | | | |
| | Succinic Anhydride | | 110.5 | | | | | |
| | Trimellitic | | | | | | | |
| | Anhydride | | | | | | | |

| Equivalent Ratio of | | 1 | 1 | 1 | 1 | 1 | 1 | 1 |
|---|---|---|---|---|---|---|---|---|
| Acid Anhydride Groups/Hydroxy groups | | | | | | | | |
| Solids Content (%) | | 70 | 70 | 70 | 70 | 70 | 70 | 60 |
| Properties | Acid Value (mg KOH/g) | 93 | 102 | 51 | 156 | 96 | 167 | 35.9 |
| | Number Average Molecular | 1200 | 1050 | 2350 | 440 | 1950 | 380 | 2950 |
| | Weight | | | | | | | |
| | Hydroxy Value (mg KOH/g) | 1> | 1> | 1> | 1> | 1> | 1> | 1> |

In Tables 1 and 2, with respect to hydroxy values, 1> means a hydroxy value of less than 1; and (*1) to (*8) indicate the following.

(*1) T-5650J: tradename of Asahi Kasei Chemicals Corp.; polycarbonate diol comprising 1,6-hexanediol and 1,5-pentanediol as diol components; number average molecular weight: 800; viscosity: 860 mPa·s; hydroxy value: 140 mg KOH/g; solids content: 100%

(*2) T-4671: tradename of Asahi Kasei Chemicals Corp.; polycarbonate diol comprising 1,6-hexanediol and 1,4-butanediol as diol components; number average molecular weight: 1,000; viscosity: 2,400 mPa·s; hydroxy value: 112 mg KOH/g; solids content: 100%

(*3) UM-CARB90: tradename of Ube Industries, Ltd.; polycarbonate diol comprising 1,6-hexanediol and 1,4-cyclohexanedimethanol as diol components; number average molecular weight: 900; viscosity: 7,000 mPa·s; hydroxy value: 124 mg KOH/g; solids content: 100%

(*4) PC-M: polycarbonate diol synthesized using 1,6-hexanediol and 3-methylpentanediol as diol components and diphenyl carbonate as a carbonylating agent; number average molecular weight: 2,000; viscosity: 7,000 mPa·s; hydroxy value: 56 mg KOH/g; solids content: 100%

(*5) PC-N: polycarbonate diol synthesized using 1,6-hexanediol and 3-methylpentanediol as diol components and diphenyl carbonate as a carbonylating agent; number average molecular weight: 380; viscosity: 120 mPa·s; hydroxy value: 260 mg KOH/g; solids content: 100%

(*6) PC-O: polycarbonate diol comprising 1,6-hexanediol and 1,4-butanediol as diol components; number average molecular weight: 1,800; viscosity: 12,000 mPa·s; hydroxy value: 125 mg KOH/g; solids content: 100%

(*7) PC-L: polycarbonate diol synthesized using 1,6-hexanediol and 3-methylpentanediol as diol components and diphenyl carbonate as a carbonylating agent; number average molecular weight: 330; viscosity: 120 mPa·s; hydroxy value: 295 mg KOH/g; solids content: 100%

(*8) PC-H: polycarbonate diol synthesized using 1,6-hexanediol and 3-methylpentanediol as diol components and diphenyl carbonate as a carbonylating agent; number average molecular weight: 2,800; viscosity: 15,000 mPa·s; hydroxy value: 40 mg KOH/g; solids content: 100%

### Production of Half Ester Group-Containing Vinyl Polymer (B-1)

### Production Example 15

A 680 part quantity of “Swasol 1000” (tradename of Cosmo Oil Co., Ltd., hydrocarbon organic solvent) was added to a four-necked flask equipped with a stirrer, a thermometer, a condenser tube, and a nitrogen gas inlet; and heated to 125° C. under aeration with nitrogen gas. After the temperature reached 125° C., aeration with nitrogen gas was stopped, and the following monomer mixture I consisting of monomers, solvent, and polymerization initiator (p-tert-butyl peroxy-2-ethylhexanoate), was added dropwise over a period of 4 hours.

Monomer Mixture I

| | |
|---|---|
| Styrene | 500 parts |
| Cyclohexyl methacrylate | 500 parts |
| Isobutyl methacrylate | 500 parts |
| Maleic anhydride | 500 parts |
| 2-Ethoxyethyl propionate | 1,000 parts |
| P-Tert-butylperoxy-2-ethylhexanoate | 100 parts |

Aging was carried out at 125° C. for 30 minutes under aeration with nitrogen gas, and then a mixture of 10 parts of p-tert-butylperoxy-2-ethylhexanoate and 80 parts of “Swasol 1000” was added dropwise over a period of 1 hour. After cooling to 60° C., 490 parts of methanol and 4 parts of triethylamine were added, and a half-esterification reaction was carried out under reflux for 4 hours.

Excessive methanol (326 parts) was then removed under reduced pressure, to thereby obtain a solution of vinyl polymer (b-1).

The obtained polymer solution had a solids content of 55 mass %, and a number average molecular weight of about 3,500. The polymer had an acid value of 130 mg KOH/g.

### Production Example 16

A 630 part quantity of “Swasol 1000” was added to a four-necked flask equipped with a stirrer, a thermometer, a condenser tube, and a nitrogen gas inlet; and heated to 125° C. under aeration with nitrogen gas. After the temperature reached 125° C., aeration with nitrogen gas was stopped, and the following monomer mixture II consisting of monomers, solvent, and polymerization initiator (p-tert-butylperoxy-2-ethylhexanoate) was added dropwise over a period of 4 hours.

Monomer Mixture II

| | |
|---|---|
| Styrene | 500 parts |
| Cyclohexyl methacrylate | 500 parts |
| Ethyl methacrylate | 665 parts |
| Maleic anhydride | 335 parts |
| 2-Ethoxyethyl propionate | 1,000 parts |
| p-Tert-butylperoxy-2-ethylhexanoate | 100 parts |

Aging was carried out at 125° C. for 30 minutes under aeration with nitrogen gas, and then a mixture of 10 parts of p-tert-butylperoxy-2-ethylhexanoate and 80 parts of “Swasol 1000” was further added dropwise over a period of 1 hour. After cooling to 60° C., 328 parts of methanol and 4 parts of triethylamine were added, and a half-esterification reaction was carried out under reflux for 4 hours. Excessive methanol (218 parts) was then removed under reduced pressure, to thereby obtain a solution of vinyl polymer (b-2).

The obtained polymer solution had a solids content of 55 mass %, and a number average molecular weight of about 3,500. The polymer had an acid value of 87 mg KOH/g.

### Production of Carboxy-Containing, High-Acid-Value Polyester (B-2)

### Production Example 17

A 566 part quantity of 1,6-hexanediol, 437 parts of trimethylolpropane, 467 parts of adipic acid, and 308 parts of hexahydrophthalic anhydride were added to a four-necked flask equipped with a stirrer, a thermometer, a condenser tube, and a nitrogen gas inlet; heated to 180° C. under a nitrogen atmosphere; and then heated to 230° C. over a period of 3 hours. After carrying out a reaction at 230° C. for 1 hour, xylene was added, and the resulting mixture was reacted under reflux. After confirming that the resin acid value had become 3 mg KOH/g or less, the reaction mixture was cooled to 100° C., and 1,294 parts of hexahydrophthalic anhydride was added. The reaction mixture was then heated to 140° C., and a reaction was carried out for 2 hours. After cooling, the reaction mixture was diluted with xylene, to thereby obtain a solution of carboxy-containing, high-acid-value polyester (b-3). The obtained polymer solution had a solids content of 65 mass %.

The polyester had a number average molecular weight of 1,040, and a resin acid value of 160 mg KOH/g.

### Production of Epoxy-Containing Acrylic Resin (C)

### Production Examples 18-25

A 410 part quantity of xylene and 77 parts of n-butanol were added to a four-necked flask equipped with a stirrer, a thermometer, a condenser tube, and a nitrogen gas inlet; and heated to 125° C. under aeration with nitrogen gas. After the temperature reached 125° C., aeration with nitrogen gas was stopped, and a monomer mixture consisting of the monomers and polymerization initiator (2,2′-azobisisobutyronitrile) shown in Table 3 was added dropwise over a period of 4 hours.

Aging was carried out at 125° C. for 30 minutes under aeration with nitrogen gas, and then a mixture of 90 parts of xylene, 40 parts of n-butanol, and 14.4 parts of azobisisobutyronitrile was further added dropwise over a period of 2 hours, followed by aging for 2 hours. Solutions of epoxy-containing acrylic resins (C-1) to (C-8) were obtained in the above manner. Epoxy-containing acrylic resin (C-1) contained only epoxy groups, whereas epoxy-containing acrylic resins (C-2) to (C-8) contained epoxy groups and ethoxysilyl groups.

Table 3 shows the amounts (parts) of monomers and polymerization initiator, solids contents (%) the obtained acrylic resin solutions, and properties of the acrylic resins.

TABLE 3

| | | Production Example | | | | | | | |
|---|---|---|---|---|---|---|---|---|---|
| | | 18 | 19 | 20 | 21 | 22 | 23 | 24 | 25 |
| Epoxy-Containing | | C-1 | C-2 | C-3 | C-4 | C-5 | C-6 | C-7 | C-8 |
| Acrylic Resin No. | | | | | | | | | |
| Styrene | | 288 | 288 | 288 | 216 | 346 | 360 | 360 | 360 |
| n-Butyl Acrylate | | 720 | 144 | 245 | | 216 | 331 | 202 | 311 |
| 2-Ethylhexyl Acrylate | | | | | 360 | | | | |
| γ- | | | 288 | 216 | 288 | 360 | 432 | 144 | 35 |
| Methacryloyloxypropyl | | | | | | | | | |
| Triethoxysilane | | | | | | | | | |
| 4-Hydroxy-n-Butyl | | | 144 | | | 144 | | 144 | 144 |
| Acrylate | | | | | | | | | |
| 2-Hydroxyethyl | | | | 187 | | | 115 | | |
| Methacrylate | | | | | | | | | |
| Glycidyl Methacrylate | | 432 | 576 | 504 | 576 | 374 | 202 | 590 | 590 |
| 2,2′- | | 72.0 | 72.0 | 72.0 | 72.0 | 72.0 | 72.0 | 72.0 | 72.0 |
| Azobisisobutylonitrile | | | | | | | | | |
| Solids Content (%) | | 70 | 70 | 70 | 70 | 70 | 70 | 70 | 70 |
| Properties | Number Average | 2000 | 2000 | 2000 | 2000 | 2000 | 2000 | 2000 | 2000 |
| | Molecular Weight | | | | | | | | |
| | Epoxy Content | 2.12 | 2.82 | 2.47 | 2.82 | 1.83 | 0.99 | 3.20 | 3.20 |
| | (mmol/g) | | | | | | | | |
| | Ethoxysilyl | — | 2.07 | 1.55 | 2.07 | 2.59 | 3.11 | 1.04 | 0.25 |
| | Content (mmol/g) | | | | | | | | |
| | Hydroxy Value | — | 39 | 56 | 1> | 39 | 39 | 39 | 39 |
| | (mg KOH/g) | | | | | | | | |

### Production of Coating Composition

### Examples 1-13 and Comparative Examples 1-3

The reaction product (A), half ester group-containing vinyl polymer (B-1) and/or carboxy-containing, high-acid-value polyester (B-2), and epoxy-containing acrylic resin (C) containing only epoxy groups, all obtained in the Production Examples, and other components, such as a curing catalyst and the like, were mixed by stirring using a rotor blade stirrer. Coating compositions No. 1 to 16 were thus obtained.

Tables 4 and 5 show the components, equivalent ratio of carboxy groups/epoxy groups, and solids contents, of the coating compositions.

TABLE 4

| | | Example | | | | | | | | |
|---|---|---|---|---|---|---|---|---|---|---|
| | | 1 | 2 | 3 | 4 | 5 | 6 | 7 | 8 | 9 |
| Coating Composition | | 1 | 2 | 3 | 4 | 5 | 6 | 7 | 8 | 9 |
| No. | | | | | | | | | | |
| Reaction | No. | A-1 | A-1 | A-2 | A-3 | A-4 | A-5 | A-6 | A-7 | A-8 |
| Product | Amount | 12 | 6 | 12 | 12 | 12 | 12 | 10.8 | 12 | 12 |
| Half Ester | No. | b-1 | b-1 | b-1 | b-1 | b-1 | b-1 | b-1 | b-1 | b-1 |
| Group- | Amount | 39 | 39 | 39 | 39 | 39 | 39 | 39 | 39 | 39 |
| Containing | | | | | | | | | | |
| Vinyl | | | | | | | | | | |
| Polymer | | | | | | | | | | |
| Carboxy-Containing | | | 12 | | | | | | | |
| Polyester Polymer | | | | | | | | | | |
| (b-3) | | | | | | | | | | |
| Epoxy- | No. | C-1 | C-1 | C-1 | C-1 | C-1 | C-1 | C-1 | C-1 | C-1 |
| Containing | Amount | 49 | 43 | 49 | 49 | 49 | 49 | 50.2 | 49 | 49 |
| Acrylic | | | | | | | | | | |
| Resin | | | | | | | | | | |

| | | | | | | | | | |
|---|---|---|---|---|---|---|---|---|---|
| Curing Catalyst(*9) | 2 | 2 | 2 | 2 | 2 | 2 | 2 | 2 | 2 |
| UV1164(*10) | 2 | 2 | 2 | 2 | 2 | 2 | 2 | 2 | 2 |
| HALS292(*11) | 2 | 2 | 2 | 2 | 2 | 2 | 2 | 2 | 2 |
| BYK-300(*12) | 0.2 | 0.2 | 0.2 | 0.2 | 0.2 | 0.2 | 0.2 | 0.2 | 0.2 |
| T-5650J(*1) | | | | | | | | | |
| Equivalent Ratio of | 1.1 | 1.5 | 1.1 | 1.2 | 1.0 | 1.0 | 0.9 | 1.1 | 1.1 |
| Carboxy Groups/ | | | | | | | | | |
| Epoxy | | | | | | | | | |
| Groups | | | | | | | | | |

TABLE 5

| | | Example | | | | Comp. Ex. | | |
|---|---|---|---|---|---|---|---|---|
| | | 10 | 11 | 12 | 13 | 1 | 2 | 3 |
| Coating Composition | | 10 | 11 | 12 | 13 | 14 | 15 | 16 |
| No. | | | | | | | | |
| Reaction | No. | A-9 | A-10 | A-11 | A-12 | — | A-13 | A-14 |
| Product | Amount | 12 | 11.6 | 17 | 13.6 | | 18.5 | 12 |
| Half ester | No. | b-1 | b-1 | b-1 | b-1 | b-1 | b-1 | b-1 |
| group- | Amount | 39 | 39 | 39 | 39 | 39 | 39 | 39 |
| containing | | | | | | | | |
| Vinyl | | | | | | | | |
| Polymer | | | | | | | | |

Carboxy-Containing
Polyester Polymer
(b-3)

| | | | | | | | | |
|---|---|---|---|---|---|---|---|---|
| Epoxy- | No. | C-1 | C-1 | C-1 | C-1 | C-1 | C-1 | C-1 |
| Containing | Amount | 49 | 49.4 | 44 | 47.6 | 49 | 42.5 | 49 |
| Acrylic | | | | | | | | |
| Resin | | | | | | | | |

| | | | | | | | |
|---|---|---|---|---|---|---|---|
| Curing Catalyst(*9) | 2 | 2 | 2 | 2 | 2 | 2 | 2 |
| UV1164(*10) | 2 | 2 | 2 | 2 | 2 | 2 | 2 |
| HALS292(*11) | 2 | 2 | 2 | 2 | 2 | 2 | 2 |
| BYK-300(*12) | 0.2 | 0.2 | 0.2 | 0.2 | 0.2 | 0.2 | 0.2 |
| T-5650J(*1) | | | | | 12 | | |
| Equivalent Ratio of | 1.1 | 1.0 | 1.5 | 1.1 | 0.9 | 1.6 | 0.9 |
| Carboxy Groups/ | | | | | | | |
| Epoxy | | | | | | | |
| Groups | | | | | | | |

In Tables 4 and 5, the amounts of the components are parts on a solids basis; and (*9) to (*12) indicate the following:

(*9) Curing catalyst: a mixture of equivalent amounts of tetrabutylammonium bromide and monobutyl phosphate

(*10) “UV1164”: tradename of Ciba-Geigy; UV absorber; 2,4-bis(2,4-dimethylphenyl)-6-(2-hydroxy-4-isooctyloxyphenyl)-1,3,5-triazine

(*11) “HALS292”: tradename of Ciba-Geigy; light stabilizer; mixture of bis(1,2,2,6,6-pentamethyl-4-piperidyl)sebacate, and methyl(1,2,2,6,6-pentamethyl-4-piperidyl)sebacate

(*12) “BYK-300”: tradename of BYK-Chemie; surface adjusting agent; polyether-modified polydimethylsiloxane

### Examples 14-32 and Comparative Examples 4-7

The reaction product (A), half ester group-containing vinyl polymer (B-1) and/or carboxy-containing, high-acid-value polyester (B-2), epoxy-containing acrylic resin (C) containing epoxy groups and ethoxysilyl groups, all obtained in the Production Examples, and other components, such as a curing catalyst and the like, were mixed by stirring using a rotor blade stirrer. Coating compositions No. 17 to 39 were thus obtained.

Tables 6 and 7 show the components, equivalent ratio of carboxy groups/epoxy groups, and solids contents, of the coating compositions.

TABLE 6

| | | Examples | | | | | | | | | | | |
|---|---|---|---|---|---|---|---|---|---|---|---|---|---|
| | | 14 | 15 | 16 | 17 | 18 | 19 | 20 | 21 | 22 | 23 | 24 | 25 |
| Coating Composition | | 17 | 18 | 19 | 20 | 21 | 22 | 23 | 24 | 25 | 26 | 27 | 28 |
| No. | | | | | | | | | | | | | |
| Reaction | No. | A-1 | A-1 | A-1 | A-1 | A-1 | A-1 | A-1 | A-1 | A-1 | A-1 | A-2 | A-3 |
| Product | Amount | 12 | 12 | 12 | 12 | 12 | 12 | 12 | 12 | 6 | 6 | 12 | 12 |
| Half ester | No. | b-1 | b-1 | b-1 | b-1 | b-1 | b-1 | b-1 | b-2 | b-1 | b-1 | b-1 | b-1 |
| group- | Amount | 39 | 39 | 39 | 39 | 39 | 39 | 39 | 39 | 39 | 39 | 39 | 39 |
| containing | | | | | | | | | | | | | |
| Vinyl | | | | | | | | | | | | | |
| Polymer | | | | | | | | | | | | | |
| Carboxy-Containing | | | | | | | | | | 12 | | | |
| Polyester Polymer | | | | | | | | | | | | | |
| (b-3) | | | | | | | | | | | | | |
| Epoxy- | No. | C-2 | C-3 | C-4 | C-5 | C-6 | C-7 | C-8 | C-2 | C-2 | C-2 | C-2 | C-2 |
| Containing | Amount | 49 | 49 | 49 | 49 | 49 | 49 | 49 | 49 | 43 | 49 | 49 | 49 |
| Acrylic | | | | | | | | | | | | | |
| Resin | | | | | | | | | | | | | |

| | | | | | | | | | | | | |
|---|---|---|---|---|---|---|---|---|---|---|---|---|
| Hydroxy-Containing | | | | | | | | | | | | |
| Acrylic Resin | | | | | | | | | | | | |
| Curing Catalyst(*9) | 2 | 2 | 2 | 2 | 2 | 2 | 2 | 2 | 2 | 2 | 2 | 2 |
| UV1164(*10) | 2 | 2 | 2 | 2 | 2 | 2 | 2 | 2 | 2 | 2 | 2 | 2 |
| HALS292(*11) | 2 | 2 | 2 | 2 | 2 | 2 | 2 | 2 | 2 | 2 | 2 | 2 |
| BYK-300(*12) | 0.2 | 0.2 | 0.2 | 0.2 | 0.2 | 0.2 | 0.2 | 0.2 | 0.2 | 0.2 | 0.2 | 0.2 |
| T-5650J(*1) | | | | | | | | | | 6 | | |
| Equivalent Ratio of | 0.8 | 0.9 | 0.8 | 1.3 | 2.4 | 0.7 | 0.7 | 0.6 | 1.1 | 0.7 | 0.8 | 0.9 |
| Carboxy | | | | | | | | | | | | |
| Groups/Epoxy Groups | | | | | | | | | | | | |

TABLE 7

| | | Examples | | | | | | | Comp. Ex. | | | |
|---|---|---|---|---|---|---|---|---|---|---|---|---|
| | | 26 | 27 | 28 | 29 | 30 | 31 | 32 | 4 | 5 | 6 | 7 |
| Coating Composition | | 29 | 30 | 31 | 32 | 33 | 34 | 35 | 36 | 37 | 38 | 39 |
| No. | | | | | | | | | | | | |
| Reaction | No. | A-4 | A-5 | A-7 | A-8 | A-9 | A-10 | A-11 | — | A-6 | A-12 | A-13 |
| Product | Amount | 12 | 12 | 12 | 12 | 12 | 12 | 17 | | 11 | 19 | 12 |
| Half ester | No. | b-1 | b-1 | b-1 | b-1 | b-1 | b-1 | b-1 | b-1 | b-1 | b-1 | b-1 |
| group- | Amount | 39 | 39 | 39 | 39 | 39 | 39 | 39 | 39 | 39 | 39 | 39 |
| containing | | | | | | | | | | | | |
| Vinyl | | | | | | | | | | | | |
| Polymer | | | | | | | | | | | | |

Carboxy-Containing
Polyester Polymer
(b-3)

| | | | | | | | | | | | | |
|---|---|---|---|---|---|---|---|---|---|---|---|---|
| Epoxy- | No. | C-2 | C-2 | C-2 | C-2 | C-2 | C-2 | C-2 | C-2 | C-2 | C-2 | C-2 |
| Containing | Amount | 49 | 49 | 49 | 49 | 49 | 49 | 44 | 49 | 50 | 43 | 49 |
| Acrylic | | | | | | | | | | | | |
| Resin | | | | | | | | | | | | |

| | | | | | | | | | | | |
|---|---|---|---|---|---|---|---|---|---|---|---|
| Hydroxy-Containing | | | | | | | | | | | |
| Acrylic Resin | | | | | | | | | | | |
| Curing Catalyst(*9) | 2 | 2 | 2 | 2 | 2 | 2 | 2 | 2 | 2 | 2 | 2 |
| UV1164(*10) | 2 | 2 | 2 | 2 | 2 | 2 | 2 | 2 | 2 | 2 | 2 |
| HALS292(*11) | 2 | 2 | 2 | 2 | 2 | 2 | 2 | 2 | 2 | 2 | 2 |
| BYK-300(*12) | 0.2 | 0.2 | 0.2 | 0.2 | 0.2 | 0.2 | 0.2 | 0.2 | 0.2 | 0.2 | 0.2 |
| T-5650J(*1) | | | | | | | | 12 | | | |
| Equivalent Ratio of | 0.8 | 0.8 | 0.8 | 0.8 | 0.8 | 0.7 | 1.1 | 0.7 | 0.7 | 1.2 | 0.7 |
| Carboxy | | | | | | | | | | | |
| Groups/Epoxy Groups | | | | | | | | | | | |

The amounts of the components shown in Tables 6 and 7 are parts on a solids basis.

### Performance Test of the Coating Compositions

Preparation of Coated Test Plates

(1) “Swasol 1000” was added to coating compositions No. 1 to No. 39 obtained in the Examples and Comparative Examples, to adjust the viscosity to 25 sec (Ford cup #4 at 20° C.).

(2) A thermosetting epoxy resin cationic electrodeposition coating composition (tradename “Elecron GT-10”, product of Kansai Paint Co., Ltd.) was applied by electrodeposition to a 0.8 mm-thick, zinc phosphate-treated dull steel plate to a film thickness of 20 μm, and cured by heating at 170° C. for 30 minutes. Subsequently, a polyester resin/melamine resin intermediate coating composition for automobiles (tradename “Amilac TP-65-2”; coating color: black; product of Kansai Paint Co., Ltd.) was applied to the electrodeposition coat by air spraying to a film thickness of 35 μm, and cured by heating at 140° C. for 30 minutes. The steel plate having the electrodeposition coat and intermediate coat was used as a substrate.

(3) An acrylic resin/melamine resin base coating composition for automobile topcoats (tradename “Aqueous Metallic Base coating WBC 713T#202”; product of Kansai Paint Co., Ltd.; coating color: black) was applied to the substrate obtained in (2) by air spraying to a film thickness of about 15 μm, allowed to stand at room temperature for 5 minutes, and preheated at 80° C. for 10 minutes. Each of the above coating compositions No. 1 to No. 39 with a viscosity as adjusted in (1) was applied on the above-obtained uncured coating layer by rotary atomization to a film thickness of about 35 μm. The coated substrate was allowed to stand at room temperature for 10 minutes, and then heated at 140° C. for 20 minutes to cure the resulting two coating layers simultaneously. Thus, coated test plates were obtained in which a multilayer topcoat film consisting of a base coating layer and a clear coating layer was formed on a substrate by a two-coat one-bake method.

(4) Coated test plates for the stain resistance test were prepared as follows: the procedure described in (2) above was followed except that a polyester resin/melamine resin intermediate coating composition for automobiles (tradename “Amilac TP-65-2”; coating color: white; product of Kansai Paint Co., Ltd.) was used in place of the polyester resin/melamine resin intermediate coating composition for automobiles (tradename “Amilac TP-65-2”; coating color: black; product of Kansai Paint Co., Ltd.), to obtain a white-color substrate; and the procedure described in (3) above was followed except that each of the coating compositions No. 1 to No. 39 was applied to the substrate, without applying the base coating composition for topcoats.

Film Performance Test

The obtained coated test plates were allowed to stand at room temperature for 7 days, and then tested for film performance in terms of scratch resistance, acid resistance, gloss, and stain resistance. The test methods are as follows.

Test Methods

Scratch resistance: the coated test plate was attached to the roof of an automobile body using water-resistant adhesive double-coated tape (product of Nichiban Co., Ltd.), and the automobile body with the coated test plate was washed 15 times in a car wash at 20° C. Thereafter, the 20° specular reflection (20° gloss) of the coated test plate was measured, and the gloss retention (%) relative to the 20° gloss before washing was calculated to evaluate the scratch resistance. The higher the gloss retention, the better the scratch resistance. The car wash used was “PO20 FWRC” (tradename of Yasui Sangyo K.K.).

Acid resistance: 0.4 cc of 40% aqueous sulfuric acid solution was dropped onto the coating film of the coated test plate. The coated test plate was then heated for 15 minutes on a hot plate heated to 60° C., and washed with water. The etching depth (μm) of the portion at which the sulfuric acid solution had been dropped was measured using a surface roughness tester (tradename “Surfcom 570A”, product of Tokyo Seimitsu Co., Ltd.), with a cutoff of 0.8 mm (scanning rate of 0.3 mm/sec, magnification of 5,000 times), to evaluate the acid resistance. The smaller the etching depth, the better the acid resistance.

Gloss: The 20° specular reflection (20° gloss) of the coated test plate was measured using a handy glossmeter (tradename “HG-268”, product of Suga Test Instruments Co., Ltd.).

Stain resistance: The coated test plate was subjected to accelerated weathering in an accelerated weathering tester (tradename “Sunshine Weather-O-Meter”, product of Suga Test Instruments Co., Ltd.) for 600 hours under the conditions according to JIS K5400. Thereafter, a staining material made of a mixture of mud, carbon black, mineral oil, and clay was applied to a piece of flannel and lightly rubbed onto the coating surface of the coated test plate. The coated test plate was then allowed to stand in a constant temperature, constant humidity room at 20° C. with a relative humidity of 75% for 24 hours, and then the coating surface was washed with running water. The degree of staining of the coating film was evaluated according to the difference in lightness (ΔL) on the coated plate. ΔL was calculated according to the following formula.

ΔL=(L value before the stain resistance test)−(L value after the stain resistance test)

The L value was measured using a tristimulus value-direct reading calorimeter (tradename “CR400”; product of Konica Minolta Co., Ltd.) using a D65 light source, with a visual field of 2 degrees, and with diffused lighting vertical reception (d/0). The L value is based on the CIE 1976 L*a*b* color system.

The degree of staining of the coating film was evaluated according to the following criteria. The smaller the ΔL value, the better the stain resistance.

a: ΔL<0.2

b: 0.2≦ΔL<0.5

c: 0.5≦ΔL<1

d: 1≦ΔL<2

e: 2≦ΔL

Tables 8 and 9 show the results of the film performance tests.

TABLE 8

| | Example | | | | | | | |
|---|---|---|---|---|---|---|---|---|
| | 1 | 2 | 3 | 4 | 5 | 6 | 7 | 8 |
| Scratch | 90 | 88 | 92 | 88 | 88 | 86 | 90 | 87 |
| Resistance | | | | | | | | |
| Acid | 0.4 | 0.4 | 0.4 | 0.4 | 0.4 | 0.4 | 0.6 | 0.4 |
| Resistance | | | | | | | | |
| (μm) | | | | | | | | |
| Stain | b | b | b | b | b | b | b | b |
| Resistance | | | | | | | | |
| Gloss | 90 | 92 | 90 | 90 | 90 | 90 | 90 | 88 |
| | Example | | | | | Comp. Ex. | | |
| | 9 | 10 | 11 | 12 | 13 | 1 | 2 | 3 |
| Scratch | 89 | 90 | 88 | 92 | 88 | 90 | 90 | 82 |
| Resistance | | | | | | | | |
| Acid | 0.4 | 0.4 | 0.4 | 0.5 | 0.4 | 0.8 | 1.2 | 0.4 |
| Resistance | | | | | | | | |
| (μm) | | | | | | | | |
| Stain | a | a | a | b | a | b | d | b |
| Resistance | | | | | | | | |
| Gloss | 90 | 90 | 88 | 90 | 85 | 90 | 90 | 40 |

TABLE 9

| | Example | | | | | | | | | | | |
|---|---|---|---|---|---|---|---|---|---|---|---|---|
| | 14 | 15 | 16 | 17 | 18 | 19 | 20 | 21 | 22 | 23 | 24 | 25 |
| Scratch | 91 | 91 | 90 | 91 | 90 | 91 | 91 | 91 | 90 | 91 | 93 | 89 |
| Resistance | | | | | | | | | | | | |
| Acid | 0.3 | 0.3 | 0.3 | 0.4 | 0.5 | 0.4 | 0.6 | 0.3 | 0.3 | 0.5 | 0.3 | 0.3 |
| Resistance | | | | | | | | | | | | |
| (μm) | | | | | | | | | | | | |
| Stain | b | b | b | b | b | b | b | b | b | b | b | b |
| Resistance | | | | | | | | | | | | |
| Gloss | 90 | 90 | 89 | 91 | 92 | 89 | 89 | 90 | 92 | 90 | 90 | 90 |

| | Example | | | | | | | Comp. Ex. | | | |
|---|---|---|---|---|---|---|---|---|---|---|---|
| | 26 | 27 | 28 | 29 | 30 | 31 | 32 | 4 | 5 | 6 | 7 |
| Scratch | 89 | 87 | 88 | 90 | 91 | 89 | 93 | 90 | 91 | 90 | 82 |
| Resistance | | | | | | | | | | | |
| Acid | 0.3 | 0.3 | 0.4 | 0.3 | 0.3 | 0.3 | 0.4 | 0.8 | 0.9 | 1.3 | 0.4 |
| Resistance | | | | | | | | | | | |
| (μm) | | | | | | | | | | | |
| Stain | b | b | b | a | a | a | b | b | d | d | b |
| Resistance | | | | | | | | | | | |
| Gloss | 90 | 90 | 88 | 90 | 90 | 88 | 90 | 90 | 90 | 90 | 40 |

1. A coating composition comprising:
(A) a carboxy-containing reaction product with an acid value of 30 to 200 mg KOH/g and a number average molecular weight of 400 to 2,500 obtained by a half-esterification reaction of an acid anhydride with a polycarbonate diol prepared by reacting a C₂₋₁₀ diol with a carbonylating agent;
(B) a carboxy-containing polymer; and
(C) an epoxy-containing acrylic resin.

2. The coating composition according to claim 1, wherein the C₂₋₁₀ diol is a mixture of 1,6-hexanediol and at least one member selected from the group consisting of 1,5-pentanediol, 1,4-butanediol, and 1,4-cyclohexanedimethanol.

3. The coating composition according to claim 1, wherein the polycarbonate diol has a Brookfield viscosity of 10,000 mPa·s or less at 50° C.

4. The coating composition according to claim 1, wherein the acid anhydride is at least one member selected from the group consisting of succinic anhydride, hexahydrophthalic anhydride, and trimellitic anhydride.

5. The coating composition according to claim 1, wherein the carbonylating agent is at least one member selected from the group consisting of alkylene carbonate, dialkyl carbonate, diallyl carbonate, and phosgene.

6. The coating composition according to claim 1, wherein the carboxy-containing polymer (B) has an acid value of 50 to 300 mg KOH/g.

7. The coating composition according to claim 1, wherein the epoxy-containing acrylic resin (C) is an epoxy- and alkoxysilyl-containing acrylic resin.

8. The coating composition according to claim 1, wherein the proportions of the carboxy-containing reaction product (A), carboxy-containing polymer (B), and epoxy-containing acrylic resin (C) are such that the equivalent ratio of carboxy groups in the components (A) and (B) relative to epoxy groups in the component (C) is 1:0.5 to 0.5:1.

9. The coating composition according to claim 1, wherein the proportions of the carboxy-containing reaction product (A) and carboxy-containing polymer (B) are, on a solids basis, 10 to 60 mass % of the component (A) and 90 to 40 mass % of the component (B), relative to the total amount of the components (A) and (B).

10. The coating composition according to claim 1, wherein the proportions of the carboxy-containing reaction product (A), carboxy-containing polymer (B), and epoxy-containing acrylic resin (C) are, on a solids basis, 20 to 80 mass % of the components (A) and (B) combined, and 80 to 20 mass % of the component (C), relative to the total amount of the components (A), (B), and (C).

11. The coating composition according to claim 1, wherein the proportion of the carboxy-containing reaction product (A) is, on a solids basis, 3 to 30 mass %, relative to the total amount of the reaction product (A), carboxy-containing polymer (B), and epoxy-containing acrylic resin (C).

12. The coating composition according to claim 1, further comprising a coloring pigment.

13. A method for forming a multilayer topcoat film, the method comprising forming on a substrate one or two colored base coating layers, and one or two clear coating layers, wherein the uppermost clear coating layer is formed using the coating composition according to claim 1.
